(19) United States
(12) Patent Application Publication
(10) Pub. No.: US 2012/0087576 A1
(43) Pub. Date: Apr. 12, 2012

(54) IMAGE PROCESSING DEVICE

(75) Inventors: Hiroshi Abe, Yokohama (JP); Akira Kumagai, Yokohama (JP)

(73) Assignee: Fujitsu Semiconductor Limited, Yokohama-shi (JP)

(21) Appl. No.: 13/181,635

(22) Filed: Jul. 13, 2011

(30) Foreign Application Priority Data
Oct. 8, 2010 (JP) 2010-228269

(51) Int. Cl. G06K 9/00

(52) U.S. Cl. 382/162

(57) ABSTRACT

An image processing device has a classification unit that generates a lookup table by dividing color palettes correlating RGB data with indices into a plurality of groups based on a relationship among R values, G values and B values of the RGB data; a storage unit that stores the lookup table; and a conversion unit that determines to which of the plurality of groups pixel data having the RGB data corresponds based on a relationship among R values, G values and B values of the pixel data, and searches for RGB data that is similar to the RGB data of the pixel data in the determined group, and outputs an index corresponding to the searched RGB data as pixel data.

### CROSS-REFERENCE TO RELATED APPLICATIONS

This application is based upon and claims the benefit of priority of the prior Japanese Patent Application No. 2010-228269, filed on Oct. 8, 2010, the entire contents of which are incorporated herein by reference.

### FIELD

The embodiment relates to an image processing device.

### BACKGROUND

Color reduction processing (color conversion processing), which reduces true color image data to index color image data, is carried out to reduce the amount of data of color images. True color image data has, for example, 8 bits (256 gradients) each of red, green and blue (RGB) image data for each pixel, and is displayed in full color.

In addition, instead of RGB color space, color space of luminance and chrominance, such as YUV color space, is composed of a Y value that represents luminance indicating color brightness, a U value obtained by subtracting the Y value from red (Y-R), and a V value obtained by subtracting the Y value from blue (Y-B). YUV color space uses less storage space than RGB color space, and YUV color space is employed for video data and the like.

On the other hand, index color image data uses indices corresponding to a plurality of colors in a color palette for pixel data. The color palette has a plurality of colors arbitrarily extracted from true colors, and each color has RGB data. In the case of a color palette having 256 types of colors, the index corresponding to each color is represented as 8 bits of data, while in the case of a color palette having 16 types of colors, each index is represented as 4 bits of data. Thus, in order to display index color image data, it is necessary to reference color palette data indicating an RGB value of the color corresponding to each index.

By carrying out color reduction processing, true color image data having 24 bits for each pixel can be converted to index color image data having 8 bits for each pixel, thereby making it possible to reduce the amount of data of color images.

Conversion of color image data of YUV color space to index color image data is described in Japanese Patent Application Laid-open No. 2003-199122. In addition, conversion of index color image data to RGB values by referring to a color palette is described in Japanese Patent Application Laid-open No. 2002-315021.

In color reduction processing, in order to convert true color image data composed of RGB values to index color image data based on correspondence between color palette RGB values and indices, it is necessary to refer to a lookup table that indicates correspondence between color palette RGB values and indices. In general, the index having RGB values, that most closely approximate RGB values of the true color image data, are searched for with the lookup table.

However, this processing involving searching through a lookup table causes the duration of color reduction processing to be prolonged, thereby yielding the need for carrying out reduction processing in a short period of time.

### SUMMARY

An image processing device has a classification unit that generates a lookup table by dividing color palettes correlating RGB data with indices into a plurality of groups based on a relationship among R values, G values and B values of the RGB data; a storage unit that stores the lookup table; and a conversion unit that determines to which of the plurality of groups pixel data having the RGB data corresponds based on a relationship among R values, G values and B values of the pixel data, and searches for RGB data that is similar to the RGB data of the pixel data in the determined group, and outputs an index corresponding to the searched RGB data as pixel data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of an image processing device in the present embodiment.

FIG. 2 is a different block diagram of an image processing device in the present embodiment.

FIG. 3 is a drawing depicting an example of a method for classifying true color image data by the lookup table generator 16 or the lookup table generation program 26.

FIG. 4 is a drawing for explaining the color groups of FIG. 3.

FIG. 5 is a drawing depicting examples of a color palette and color palette groups in the present embodiment.

FIG. 6 is a drawing depicting examples of a color palette and color palette groups in the present embodiment.

FIG. 7 is a flow chart of lookup table generation in the present embodiment.

FIG. 8 is a flow chart depicting a first color reduction processing in the present embodiment.

FIG. 9 is a flow chart depicting a second color reduction processing of the present embodiment.

FIG. 10 is a flow chart depicting a third color reduction processing of the present embodiment.

### DESCRIPTION OF EMBODIMENT(S)

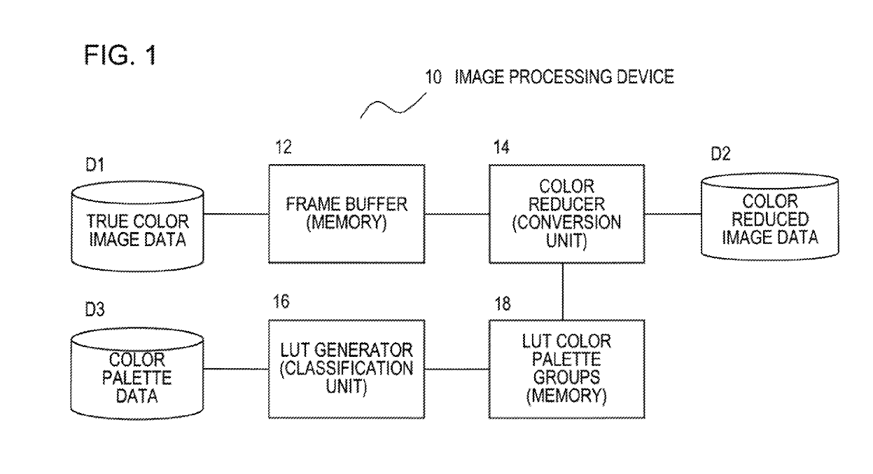

FIG. 1 is a block diagram of an image processing device in the present embodiment. An image processing device 10 converts true color image data D1 serving as first image data to index color image data D2 serving as second image data that uses indices of a color palette as pixel data. The image processing device 10 has a frame buffer 12, which stores the true color image data D1 targeted for color reduction processing, a lookup table generator 16, which generates a lookup table composed of color palette groups by classifying color palette data D3 into a plurality of groups, a memory 18 that stores the lookup table, and a color reducer 14, which converts each of the pixel data of the first image data D1 in the frame buffer 12 to color indices corresponding to colors in the color palettes by referring to the lookup table, and outputs the second image data D2 that uses indices as pixel data.

Each pixel data of the true color image data D1 is 24-bit data composed of 8 bits each of RGB data. Each RGB has 8 bits and 256 gradients, and is capable of rendering 16,777,216 colors when mixed. On the other hand, the color palette data D3 is composed of a plurality of colors arbitrarily extracted from 16,777,216 true colors, and the plurality of colors each have RGB data. In the color palette data D3, the plurality of colors is correlated with indices. In the case the indices have 8 bits, the number of colors becomes 256, while in the case the indices have 4 bits, the number of colors becomes 16.

In comparison with the true color image data D1, in which each pixel is 24-bit RGB data, the second image data D2 serving as index color image data, in which each pixel has index data, has a smaller amount of data. Thus, the amount of data is reduced by converting the first image data D1 to the second image data D2. Consequently, index colors are suitable for displaying on web pages or displaying on television menu screens.

The lookup table generator 16 is a classification unit that generates a lookup table by dividing the color palette data D3 into a plurality of groups based on the relationship among R values, G values and B values of the multiple color RGB data. The lookup table (LUT) generator 16 classifies the plurality of colors of the color palette data D3 into, for example, a plurality of hue groups having colors of similar hue. Alternatively, the LUT generator 16 may also classify the plurality of colors of the color palette data D3 into a plurality of gray groups in which RGB values have equivalent gray colors in addition to classifying into a plurality of hue groups. Classification methods are subsequently described.

The color reducer 14 is a conversion unit that converts the first image data D1 into the second image data D2. The color reducer 14 detects a color having RGB values similar to RGB values of each pixel data of the true color image data D1 among the plurality of colors of the color palette in the lookup table 18, and outputs the second image data D2 that uses the index of the detected color as pixel data.

In order to accomplish this, the color reducer 14 first determines to which group in the lookup table the RGB values of pixel data of the true color image data D1 belong based on the relationship among the R value, G value and B value of the pixel data. Determination methods are subsequently described.

Moreover, the color reducer 14 searches for a plurality of colors in the determined group, and detects a color having RGB data similar to RGB data of the pixel data of the true color image data D1. The color reducer 14 then outputs the second image data D2 having an index corresponding to the detected color as pixel data. The detection method is subsequently described.

Thus, firstly, since true colors are directly converted into index colors by using RGB data of the true color image data D1 as is, the number of conversion steps is low. Secondly, since index colors are divided into a plurality of groups in the lookup table 18, and index colors are detected from groups that includes resemble colors of the true color image data, detection efficiency is better than in the case of not classifying into groups, thereby enabling conversion processing of image data to be carried out in a short period of time.

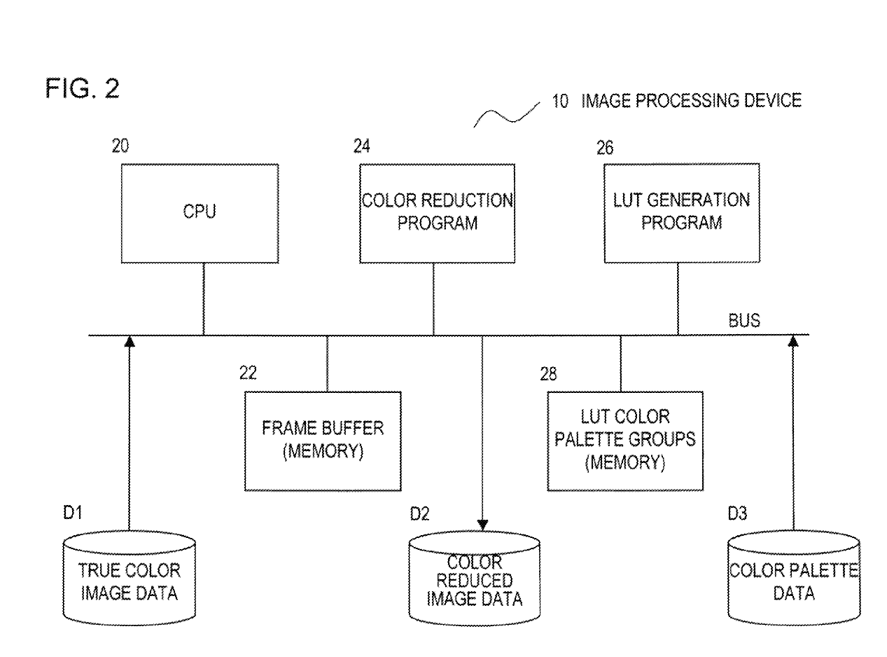

FIG. 2 is a different block diagram of an image processing device in the present embodiment. This image processing device 10 has a color reduction program 24 that carries out color reduction processing, a memory that stores a lookup table generation program 26 that generates a lookup table by classifying a color palette into groups, and a CPU 20 that executes both of the programs 24 and 26. Moreover, the image processing device 10 has a frame buffer 22, which stores the first image data D1 serving as true color image data, and a lookup table 28, in which the color palette data D3 is grouped into a plurality of colors. The frame buffer 22 and the lookup table 28 are both memories. These are coupled via a bus BUS.

In this image processing device 10, generation of the lookup table as explained in FIG. 1 and color reduction processing are carried out by a CPU 20 executing the lookup table generation program 26 and the color reduction program 24. Thus, conversion efficiency is improved and color conversion is carried out in a short period of time in the same manner as FIG. 1.

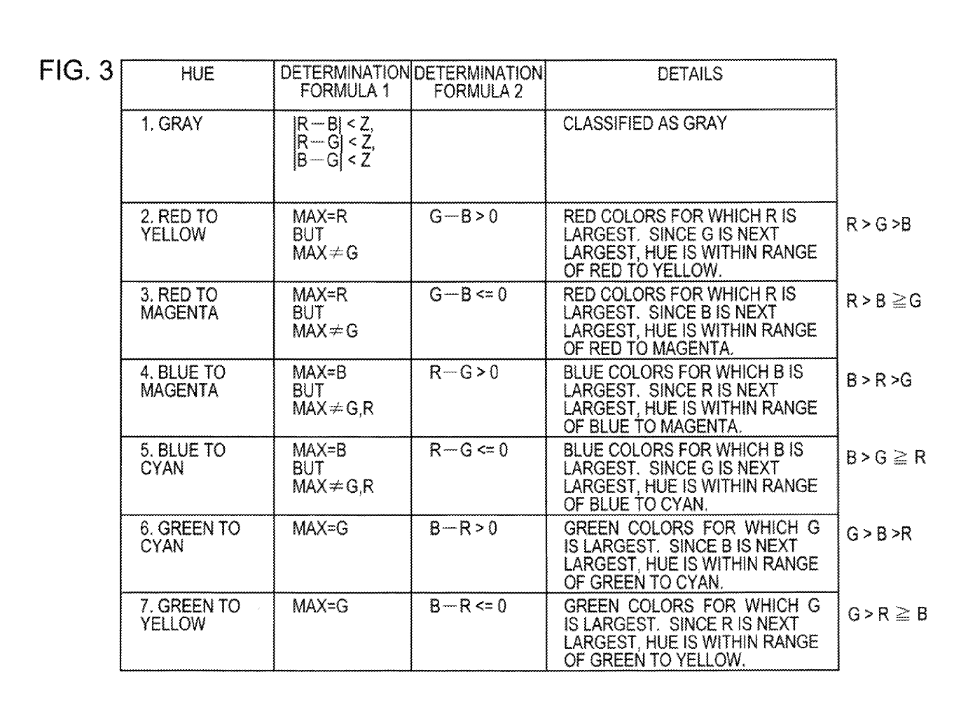

FIG. 3 is a drawing depicting an example of a method for classifying true color image data by the lookup table generator 16 or the lookup table generation program 26. The lookup table generator or the lookup table generation program classify a plurality of colors (e.g., 256 colors) of the color palette data D3 into a plurality of hue groups 2 to 7 based on the relationship among R values, G values and B values of the RGB data thereof. In order to classify into the plurality of hue groups, it is preferable in terms of simplifying determination to classify according to the order of the largeness of RGB values of the colors of the color palette data.

As indicated in the determination formulas 1 and 2 of FIG. 3, colors are classified in the following manner. First, colors for which G value among R, G and B values is the largest and in which B value is greater than R value (G>B>R) are classified as group 6 including green to cyan, while colors for which G value is the largest and the R value is equal to or greater than B value (G>R≧B) are classified as group 7 including green to yellow.

Next, colors for which R value is the largest, G value is not the largest, and G value is greater than B value (R>G>B) are classified as group 2 including red to yellow, while colors for which R value is the largest, G value is not the largest, and B value is equal to or greater than G value (R>B≧G) are classified as group 3 including red to magenta.

Finally, colors for which B value is the largest, G or R value is not the largest, and R value is greater than G value (B>R>G) are classified as group 4 including blue to magenta, while colors for which B value is the largest, G or R value is not largest, and G value is equal to or greater than R value (B>G≧R) are classified as group 5 including blue to cyan.

According to the classification method described above, the lookup table generator 16 is able to be composed with a simple logic circuit, while the lookup table generation program 26 is able to be composed with a simple processing step.

Color classification may also include classifying colors for which R, G and B values are equal as a gray group 1 in addition to classifying in the six hue groups described above. In the case of classifying as gray group 1, it is preferable to carry out processing for determining whether or not the absolute values of the respective differences among the R, G and B values are smaller than a reference value Z prior to classifying into the above-mentioned six hue groups. This is because colors belonging to this gray group ends up being classified by being dispersed among the six hue groups.

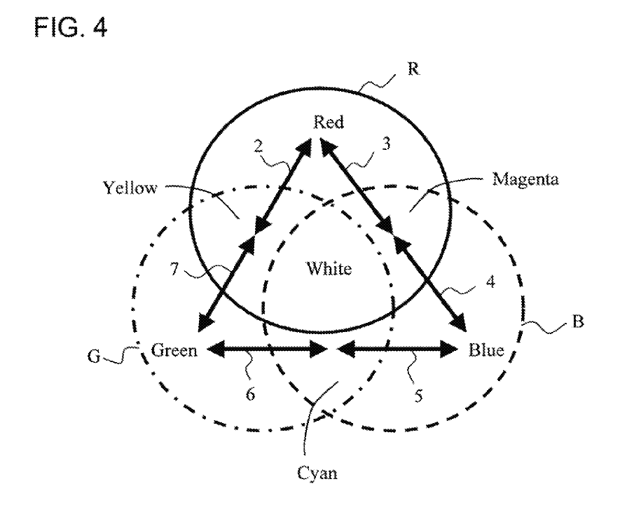

FIG. 4 is a drawing for explaining the color groups of FIG. 3. Colors in the case the colors of R, G and B have been mixed are depicted in FIG. 4. The product of mixing R and G is yellow, that of mixing G and B is cyan, and that of mixing B and R is magenta. Thus, the groups 2 to 7 of the six hues depicted in FIG. 3 are colors belonging to the regions indicated with the arrows in FIG. 4.

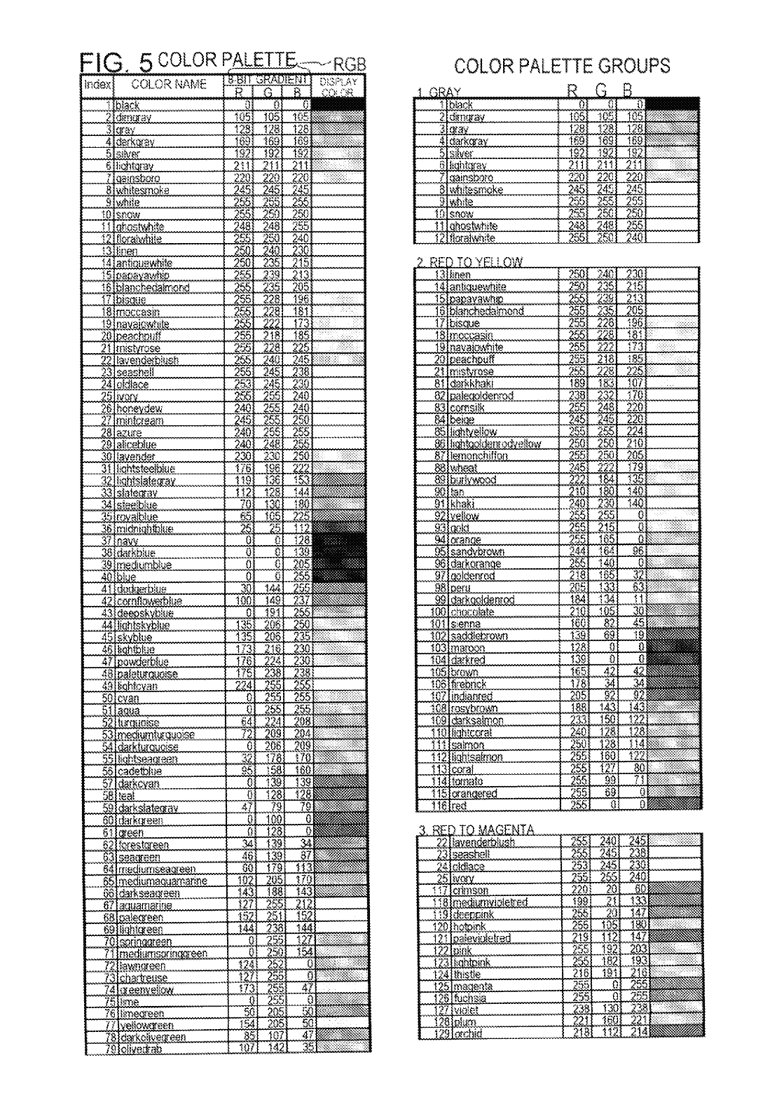

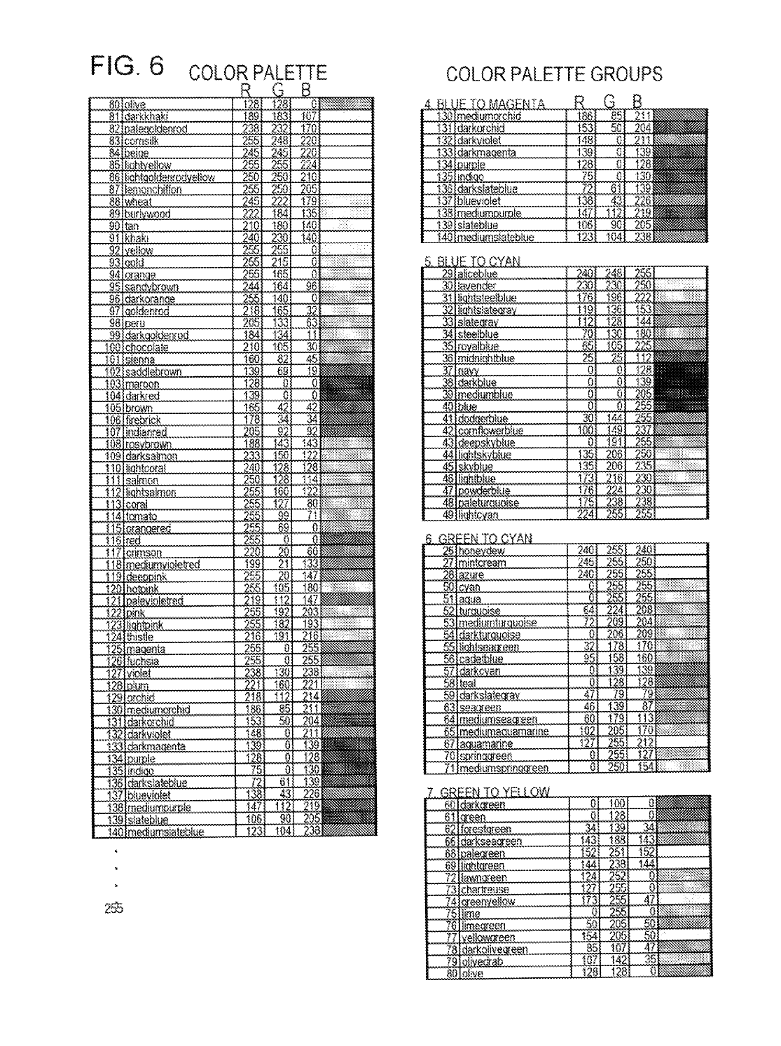

FIGS. 5 and 6 are drawings depicting examples of a color palette and color palette groups in the present embodiment. The color palettes on the left side of FIGS. 5 and 6 have 256 colors. However, 140 colors are depicted. RGB values and an 8-bit index (decimal display) are correlated for each color. On the other hand, color palette groups are depicted on the right side of FIGS. 5 and 6. The gray group 1 along with groups 2 to 7 for each hue depicted in FIG. 3 are depicted. Actual colors are displayed in the display color columns of the color palettes on the left and right sides in FIGS. 5 and 6. However, their gray displays are depicted in FIGS. 5 and 6.

In looking at the color palette groups, RGB values of each color is seen to have RGB values corresponding to the determination formulas 1 and 2 of FIG. 3. For example, the gray group 1 is composed of colors for which RGB values are all equal. Group 2 (red to yellow) is composed of colors for which there is the relationship R>G>B. Group 3 (red to magenta) is composed of colors for which there is the relationship R>B≧G. Group 4 (blue to magenta) is composed of color for which there is the relationship B>R>G. Group 5 (blue to cyan) includes colors for which there is the relationship B>G≧R. Group 6 (green to cyan) is composed of colors for which there is the relationship G>B>R. Finally, group 7 (green to yellow) is composed of colors for which there is the relationship G>R≧B.

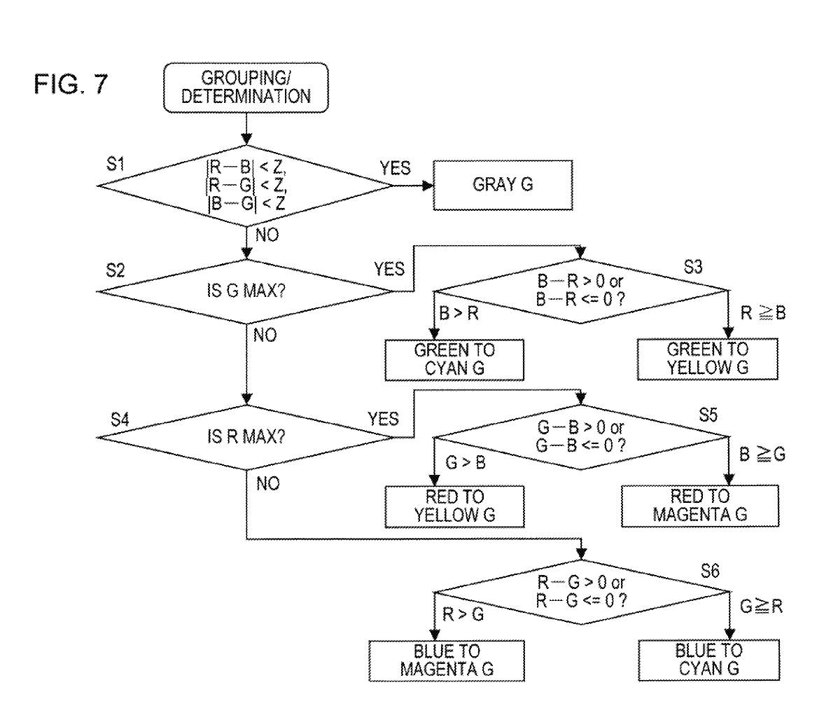

FIG. 7 is a flow chart of lookup table generation in the present embodiment. In generating the lookup table, each color of a given color palette is classified into one of six hue groups based on the above-mentioned determination formulas, or is classified in a total of 7 groups including the gray group and six hue groups, on the basis of the relationship among their RGB values. Colors are classified into 7 groups in the example depicted in FIG. 7.

A determination is made for each color of the color palette as to which of the 7 groups it belongs according to determination steps S1 to S6 depicted in FIG. 7. First, a determination is made as to whether or not the absolute values of respective differences among the RGB values of a color (R-B, R-G and B-G) are all less than the reference value Z (S1), and if the result of this determination is YES, then that color is classified in the gray group.

Next, a determination is made as to which of the six hue groups the color belongs. First, a determination is made as to whether or not G value is the largest (S2), and if the result of this determination is YES, then a determination as whether the relationship between B and R is B>R or R≧B (S3), and the color is classified into the green to cyan group or the green to yellow group corresponding to the result of this determination. Next, in the case G value is not the largest, a determination is made as to whether or not R value is the largest (S4), and if the result of this determination is YES, then a determination is made as to whether the relationship between G and B is such that G>B or B≧G (S5), and the color is classified into the red to yellow group or red to magenta group corresponding to the result of this determination. Finally, in the case neither the R or G value is the largest, a determination is made as to whether the relationship between R and G is such that R>G or G≧R (S6), and the color is classified into the blue to magenta group or the blue to cyan group corresponding to the result of this determination.

Although not depicted in the drawing, the colors of each group are preferably arranged in order of decreasing luminance values. This is based on the property of the human eye that makes it sensitive to luminance while insensitive to changes in hue. Luminance values are determined according to the following formula.

Luminance value=0.6G+0.3R+0.1B (1)

As a result, the color palette groups are stored in memory as the lookup table 18.

In the grouping described above, colors may also be classified as a gray group in addition to the six hue groups. By providing the gray group in this manner for achromatic colors (white to gray or black) that do not have color information, achromatic colors are still treated as achromatic colors in pixel data even if there are slight changes in hue contained therein. As a result, colors of continuous pixels is determined to belong to the gray group in natural images or CG images in which similar colors continue easily.

In addition, although RGB color space does not have hue, such RGB color data is directly classified into hue groups by using the determination methods described above. Thus, color data of RGB color space is classified into a hue group without having to convert to the color data of RGB color space into color data of YUV color space.

[First Color Reduction Processing]

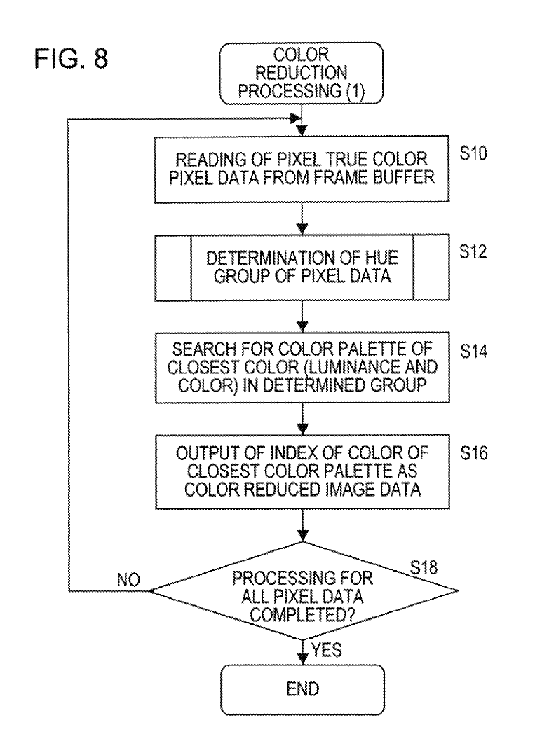

FIG. 8 is a flow chart depicting a first color reduction processing in the present embodiment. The color reducer 14 or the color reduction program 24 reads true color pixel data of a pixel from the frame buffer 12 or 22 (S10).

A determination is then made as to which group the pixel data belongs using the same determination method as the grouping of FIG. 7 based on the relationship among RGB values of that pixel data (S12). Thus, this group determination is the same as the determination depicted in FIG. 7. In this case as well, color data of RGB color space is divided into hue groups based on the relationship among RGB values without having to convert to color data of YUV color space.

Next, the color reducer 14 or the color reduction program 24 searches for a color that most closely approximates the color of the true color pixel data from the plurality of colors in the determined group (S14). The target of this search is the RGB values of all colors in the determined group. The method to derive the closest color in the determined group is as indicated below, and the color having the smallest D value is the color of the color palette that most closely approximates.

D=g×|Gi−Gt|+r×|Ri−Rt|+b×|Bi−Bt| (2)

Here, Gi, Ri and Bi represent RGB values of the true color pixel data, while Gt, Rt and Bt represent RGB values of the color palette in the group. In addition, g, r and b represent weighting factors of G, R and B values.

In the case all of the weighting factors are 1, then the color for which RGB values are the closest is simply detected. In addition, if the weighting factors are made to be the same as formula (1) for calculating luminance, then the color for which luminance and color are closest is detected. If the weighting factors are made to be intermediate values between 1 and the coefficients of formula (1), then the color for which luminance is closest is detected. By detecting the color for which luminance is closest, a color that is closest for the human eye is detected by taking advantage of the property of the human eye of being sensitive to luminance but insensitive to changes in hue.

In this manner, by detecting the closest color in the determined group, the number of colors of the color palette targeted for searching is reduced, thereby making it possible to reduce the number of search steps and enable high-speed processing.

As a result of the above-mentioned search, an index of closest color palette color is output as pixel data of color reduced image data (S16).

The steps S10 to S16 described above are repeated until processing of all pixel data has been completed (S18).

[Second Color Reduction Processing]

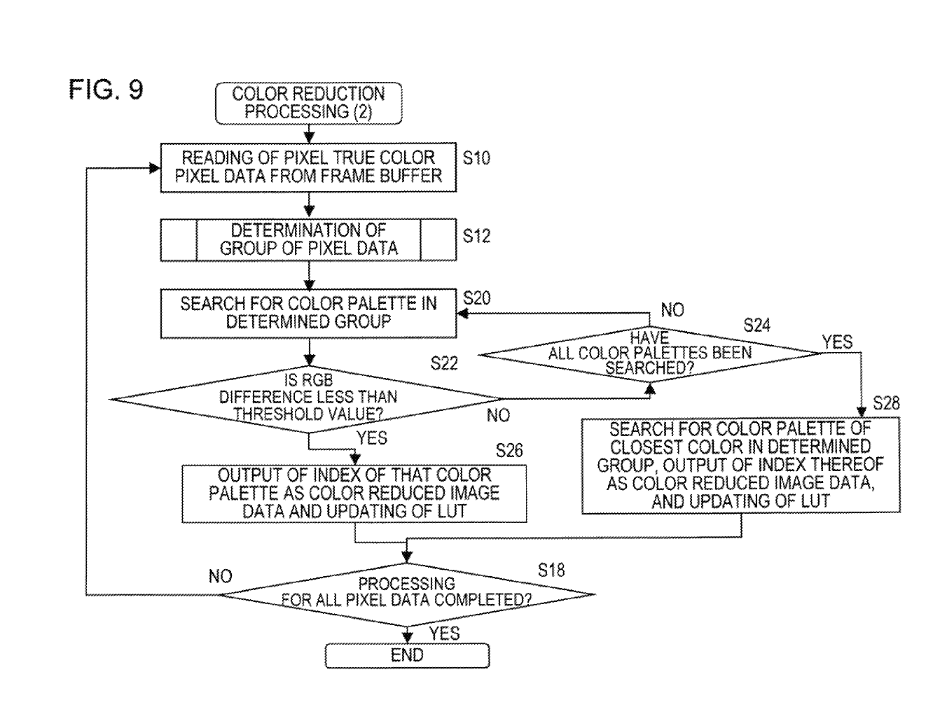

FIG. 9 is a flow chart depicting a second color reduction processing of the present embodiment. Steps S10, S12 and S18 are the same processing as the corresponding steps of FIG. 8.

In the second color reduction processing, the method to search the color palette in a determined group differs from that of the first color reduction processing. In the second color reduction processing, threshold values Xg, Xr and Xb of a degree that does not present a problem visually are set, and a search is made in a detected group for those colors of a color palette for which differences between R values, G values and B values, or values obtained by multiplication of R values, G values and B values by coefficients become less than all of the threshold values Xg, Xr and Xb (S20, S22). In the case an applicable color palette color is detected, search processing ends at that time (Yes in S22).

The determination method of search processing is as indicated below.

(g×|Gi−Gt|<Xg)

and

(r×|Ri−Rt|<Xr)

and

(b×|Bi−Bt|<Xb) (3)

Although conversion accuracy is increased by setting these threshold values Xg, Xr and Xb to small values, detection efficiency is increased and detection is carried out in a short period of time by setting these values to large values. Thus, these threshold values are preferable able to altered and set dynamically.

When a color of the color palette has been detected that satisfies the determination formula (3) indicated above, the color reducer or the color reduction program outputs the index thereof as pixel data of color reduced image data D2 (S26). Moreover, in this second color reduction processing, the lookup table is updated so that the detected color palette color is ranked first in the searching order within the detected group. (S26)

This processing for updating the lookup table has the following advantages. Namely, in a natural image in which there is a high probability of a hue of an adjacent pixel not undergoing a sudden change, the probability of detecting a similar color palette color within the group is increased. In addition, in a CG image in which the probability of the hue and luminance of an adjacent pixel continuing is high, the probability of detecting a similar color palette color is also increased. Moreover, in the case the weighting factors g, r and b are set for the coefficients of the luminance calculation formula or are set to coefficients close to those coefficients, a color having similar luminance is detected, and the probability of detecting a similar color palette color is increased by taking advantage of the property of the human eye of being sensitive to luminance and insensitive to changes in hue.

In the case a color palette color satisfying the above-mentioned determination formula (3) is not found in a determined group (YES in S24), a color palette of the closest color is searched for in the determined group, and the index of the detected color palette is output as pixel data (S28). The determination method of this search is the same as that of the first color reduction processing. Moreover, that color is then updated to be ranked first in the searching order within that group (S28).

The processing described above is then repeated for pixel data of the second pixel and beyond (S18).

[Third Color Reduction Processing]

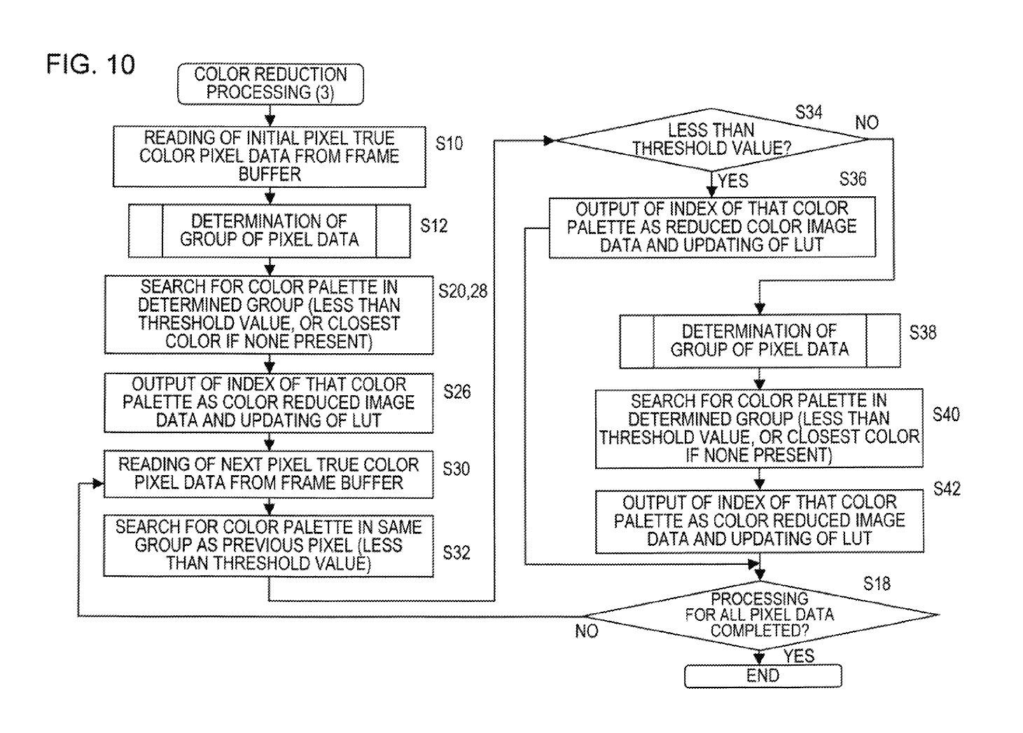

FIG. 10 is a flow chart depicting a third color reduction processing of the present embodiment. In the third color reduction processing, the firstly processed true color pixel data is subject to the second color reduction processing. Namely, the true color pixel data of the first pixel is read from the frame buffer (S10), and a determination is made as to which color pixel group the pixel data belongs (S12). A search is then made of color palettes within the determined group, and a color palette color for which differences with RGB values of the true color pixel data are each smaller than a threshold value is then searched for according to formula (3) (S20, 28). In the case there is no color for which the difference is smaller than the threshold value, a color is detected among a plurality of colors in the determined group for which the difference value D of formula (2) is the smallest (S20, 28). The index of the detected color palette is then output as pixel data of color reduced image data D2, and that color palette is updated to be ranked first in the searching order in that group (S26).

True color pixel data of the next processed pixel is then read from the frame buffer (S30). A search is then made for a color palette within the same group as determined for the previous pixel, and a search is made for a color of that color palette for which the differences with RGB values of true color pixel data are each smaller than a threshold value according to formula (3) (S32). The reason for searching the same group as the previous pixel first is because, in the case of natural images of CG images, the color of an adjacent pixel frequently has hue that is equal to that of the previous pixel or has hue and luminance that are equal to those of the previous pixel. By using the same group as the previous pixel as the target of the search, the step for determining the group to which the next true color pixel data belongs is omitted.

If a color palette satisfying the formula (3) is detected (YES in S34), the index of the detected color palette is output as pixel data of color reduced image data, and the lookup table is updated so that the detected color palette is ranked first in the searching order of that group (S36).

On the other hand, in the case a color palette satisfying the formula (3) is not detected (NO in S34), a determination is made as to which group that true color pixel data belongs (S38). This determination is carried out as depicted in FIG. 7 as previously described. A search is then made of color palettes in the determined group, and a search is made for a color palette color for which the differences with RGB values of true color pixel data are each smaller than a threshold value according to formula (3) (S40). If there is no color palette color satisfying the formula (3), color is detected among a plurality of colors in the determined group for which the difference value D of formula (2) is the smallest (S40). In other words, step S40 is the same as the previously described steps S20 and S28.

The index of the detected color palette is then output as pixel data of color reduced image data D2, and that color palette is updated so as to be ranked first in the searching order within that group (S42). This step is the same as the previously described step S26.

In this manner, in the case a color palette for which the difference is smaller than the threshold value is not present in the group determined with the previous pixel in step S32, the color of the true color pixel data in the frame buffer is considered to have been changed to a completely different color, and processing is preferably repeated starting from determination of the group.

In the third color reduction processing, since a color pixel for which the difference is less than a threshold value is searched within a group determined with a previous pixel without having to determine the group for the color pixel, in the case an adjacent pixel of the first image data repeats the same hue or repeats the same luminance and hue, conversion efficiency is increased and the time used for color reduction processing is shortened.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. An image processing device, comprising:
a classification unit that generates a lookup table by dividing color palettes correlating RGB data with indices into a plurality of groups based on a relationship among R values, G values and B values of the RGB data;
a storage unit that stores the lookup table; and
a conversion unit that determines to which of the plurality of groups pixel data having the RGB data corresponds based on a relationship among R values, G values and B values of the pixel data, and searches for RGB data that is similar to the RGB data of the pixel data in the determined group, and outputs an index corresponding to the searched RGB data as pixel data.

2. The image processing device according to claim 1, wherein
the plurality of groups have a plurality of hue groups, and
the classification unit classifies a plurality of colors included in the color palettes into any of the plurality of hue groups, based on order of largeness of R values, G values and B values of the RGB data of the colors.

3. The image processing device according to claim 1, wherein
the plurality of groups have a gray group and a plurality of hue groups, and
the classification unit classifies, among the plurality of colors included in the color palettes, colors, for which an absolute value of respective differences between R values, G values and B values of RGB data of the colors is smaller than a reference value, into the gray group.

4. The image processing device according to claim 3, wherein
the classification unit further classifies the plurality of colors included in the color palettes into any of the plurality of hue groups, based on the order of largeness of R values, G values and B values of RGB data of the colors.

5. The image processing device according to claim 2, wherein the order of largeness of R values, G values and B values of RGB data of the colors is in order RGB, order RBG, order GRB, order GBR, order BRG or order BGR.

6. The image processing device according to claim 4, wherein the order of largeness of R values, G values and B values of RGB data of the colors is in order RGB, order RBG, order GRB, order GBR, order BRG or order BGR.

7. The image processing device according to claim 1, wherein the conversion unit searches for RGB data similar to RGB data of adjacent pixel data, which is adjacent to the pixel data, in the group determined with respect to the pixel data.

8. The image processing device according to claim 6, wherein the conversion unit determines to which of the plurality of groups the pixel data of first image data corresponds, based on the relationship among R values, G values and B values of the pixel data, in a case a color having similar RGB data is unable to be detected in the search.

9. The image processing device according to claim 1, wherein the conversion unit further updates the lookup table by relocating the searched RGB data to a location ranked first in the searching order in the group.

10. The image processing device according to claim 1, wherein the conversion unit searches for RGB data similar to the RGB data of the pixel data in the determined group, based on whether or not a difference between the RGB data of the pixel data and the RGB data in the determined group is the smallest.

11. The image processing device according to claim 1, wherein the conversion unit searches for RGB data similar to the RGB data of the pixel data in the determined group, based on whether or not the difference between the RGB data of the pixel data and the RGB data in the determined group is smaller than a reference value.

12. The image processing device according to claim 10, wherein the conversion unit searches for a color having RGB data similar to the RGB data of the pixel data among a plurality of colors in the determined group, based on whether or not the difference between the RGB data of the pixel data and the RGB data of a plurality of colors in the determined group is the smallest, in a case where the difference between the RGB data of the pixel data and the RGB data of a plurality of colors in the determined group is not smaller than a reference value.

13. The image processing device according to claim 1, wherein the conversion unit searches for a color having RGB data similar to the RGB data of the pixel data among a plurality of colors in the determined group, based on whether or not a difference in luminance between the RGB data of the pixel data and the RGB data of a plurality of colors in the determined group is the smallest.

14. A computer-readable image processing program that causes a computer to execute steps comprising:
generating a lookup table in which color palettes correlating RGB data with indices are divided into a plurality of groups, based on a relationship among R values, G values and B values of the RGB data;
determining to which of the plurality of groups pixel data having RGB data corresponds based on a relationship among R values, G values and B values of the pixel data;
searching for RGB data that is similar to the RGB data of the pixel data in the determined group; and
outputting an index corresponding to the searched RGB data as pixel data.

15. The image processing program according to claim 14, wherein
the plurality of groups have a plurality of hue groups, and
in the step of generating the lookup table, a plurality of colors of the color palettes are classified into any of the plurality of the hue groups, based on order of largeness of R values, G values and B values of the RGB data of the colors.

16. The image processing program according to claim 14, wherein
the plurality of groups have a gray group and a plurality of hue groups, and
in the step of generating the lookup table, among the plurality of colors of the color palettes, colors, for which an absolute value of respective differences between R values, G values and B values of RGB data of the colors is smaller than a reference value, are classified into the gray group, and
a plurality of colors of the color palettes are classified into any of the plurality of the hue groups, based on order of magnitude of R values, G values and B values of the RGB data of the colors.

17. An image processing method, comprising:
generating a lookup table in which color palettes correlating RGB data with indices are divided into a plurality of groups, based on a relationship among R values, G values and B values of the RGB data;
determining to which of the plurality of groups pixel data having RGB data corresponds, based on a relationship among R values, G values and B values of the pixel data;
searching for RGB data that is similar to the RGB data of the pixel data in the determined group; and
outputting an index corresponding to the searched RGB data as pixel data.
